(19) United States
(12) Patent Application Publication
(10) Pub. No.: US 2004/0081439 A1
(43) Pub. Date: Apr. 29, 2004

(54) Actively-controlled electrostatic chuck heater

(75) Inventors: Arnold Kholodenko, San Francisco, CA (US); Senh Thach, Union City, CA (US); Dennis Grimard, Ann Arbor, MI (US)

Correspondence Address: Patent Counsel, Applied Materials, Inc., P.O. Box 450A, Santa Clara, CA, 95052, US

(73) Assignee: Applied Materials, Inc.

(21) Appl. No.: 10/692,901

(22) Filed: Oct. 24, 2003

Related U.S. Application Data
(63) Continuation of application No. 09/565,199, filed on May 4, 2000, now abandoned.

(51) Int. Cl. A21B 2/00

(52) U.S. Cl. 392/416

(57) ABSTRACT

An apparatus for controlling a temperature of a substrate during semiconductor substrate processing including a semiconductor substrate processing chamber and a substrate support disposed in the chamber. The substrate support includes heater electrode adapted for connection to a power source and disposed within the substrate support, and a meter coupled to the heater electrode for measuring resistivity of the heater electrode as an indicator of the temperature of the heater electrode. A controller is also coupled to the meter and the power source wherein the controller regulates power distribution from the power source to the heater electrode based upon a temperature of the heater electrode, where the temperature is determined from a measured resistivity of the heater electrode.

### CROSS-REFERENCE TO RELATED APPLICATIONS

This application is a continuation of co-pending U.S. patent application Ser. No. 09/565,199 filed May 4, 2000, which is herein incorporated by reference.

### BACKGROUND OF THE DISCLOSURE

1. Field of the Invention

The invention relates to an apparatus for processing a semiconductor wafer. More particularly, the invention relates to an apparatus for controlling the temperature of a wafer support pedestal.

2. Description of the Background Art

Substrate supports are widely used to support substrates (i.e., semiconductor wafers) within semiconductor processing systems. These supports are used to support and/or retain semiconductor wafers, or other substrates, in a stationary position in the process chamber during processing.

Typically, the substrate support contains one or more electrodes (i.e., heating electrodes) embedded within the substrate support body. The heater electrode may be used to raise the temperature of the wafer and thereby enhance the process that such wafer is undergoing (e.g. etching, physical vapor deposition, or chemical vapor deposition). Additionally, the temperature of the substrate support is usually monitored via thermocouples placed in vicinity of the heater electrode. However, the temperature that is measured by the thermocouples is dependent upon their proximity to the heater electrode. Thus, the closer to the heater electrode, the greater the accuracy in monitoring temperature.

One disadvantage of using thermocouples is that the thermocouples are not in close proximity to the heater electrode, and thereby result in inaccurate temperature readings. As such, the temperature may exceed design constraints during the processing before corrective action can be taken. Additionally, there is increased design and manufacturing complexity of a substrate support caused by the thermocouple feed-through wiring and similar wiring. Therefore, a need exists in the art for an apparatus that is capable of monitoring and self-regulating the temperature of the substrate support.

### SUMMARY OF THE INVENTION

The disadvantages associated with the prior art are overcome by the present invention of an apparatus for controlling a temperature of a substrate during semiconductor substrate processing, comprising a semiconductor substrate processing chamber and a substrate support disposed in the chamber. The substrate support includes a heater electrode adapted for connection to a power source and disposed within the substrate support, and a meter coupled to the heater electrode for measuring a characteristic of the heater electrode as an indicator of temperature of the heater electrode.

A controller is also coupled to the meter and the power source, wherein the controller regulates power distribution from the power source to the heater electrode based upon a temperature of the heater electrode. It is noted that the temperature is determined by a measured resistivity of the heater electrode.

Thus, the apparatus for actively-controlling a heater electrode embedded within a substrate support advantageously allows greater accuracy in determining the temperature of the substrate support, as opposed to the use of thermocouples. Furthermore, the apparatus inventively provides the ability to self-regulate the temperature by adjusting the power source to the heater electrode.

### BRIEF DESCRIPTION OF THE DRAWINGS

The teachings of the present invention can be readily understood by considering the following detailed description in conjunction with the accompanying drawings, in which:

FIG. 1 depicts a schematic diagram of a plasma processing apparatus containing the present invention;

FIG. 2 depicts a detailed view of a substrate support of the present invention;

FIGS. 3A and 3B depict graphs of resistivity versus temperature for various metals; and

FIG. 4 depicts a flowchart of a method of controlling temperature of a substrate support in accordance with the present invention.

To facilitate understanding, identical reference numerals have been used, where possible, to designate identical elements that are common to the figures.

### DETAILED DESCRIPTION

The present invention relates to improvements in an apparatus for supporting a substrate during a silicon etching or deposition process. Such substrate processing may be conducted (but not necessarily required) in a plasma-based environment. Specifically, the invention relates to an apparatus for actively controlling a heating electrode embedded in a semiconductor substrate (wafer) support utilizing the properties of electrical resistivity of the electrode material.

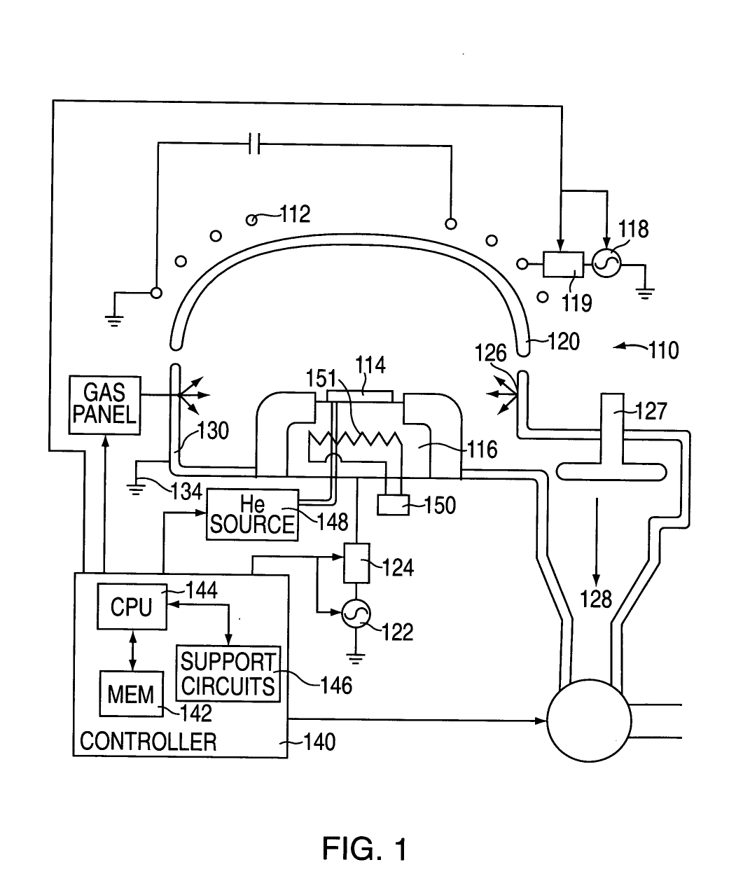

FIG. 1 depicts a simplified schematic diagram of an etch processing chamber 110. Although the preferred embodiment will be described in terms of a decoupled plasma source (DPS) etching chamber manufactured and sold by Applied Materials, Inc. of Santa Clara, Calif., one skilled in the art will recognize that the inventive substrate support utilizing a heating electrode as a sensor may be incorporated into any other semiconductor wafer processing chamber. Such chambers may illustratively include physical vapor deposition (PVD) chambers or chemical vapor deposition CVD chambers.

The process chamber 110 is constructed to include at least one inductive coil antenna segment 112, positioned exterior to a dielectric, dome-shaped ceiling 120 (referred to herein as the dome 120), and connected to a radio-frequency (RF) source 118 (which is generally capable of producing an RF signal having a tunable frequency of about 12.56 MHz). The RF source 118 is coupled to the antenna 112 through a matching network 119. Process chamber 110 also includes a substrate support (cathode) 116 for supporting a substrate 114 to be processed. The substrate support 116 is connected to a second RF source 122. The RF source 122 is generally capable of producing a RF signal having a frequency in the range of 50 kHz to 15 MHz. For example, in the case of a deep trench etch process conducted in the chamber 110, a bias frequency of about 400 kHz is used. The source 122 is coupled to the cathode 116 through a matching network 124. The chamber 110 also contains a conductive chamber wall 130 that is connected to an electrical ground 134. A controller 140 comprising a central processing unit (CPU) 144, a memory 142, and support circuits 146 for the CPU 144 is coupled to the various components of the chamber 110 to facilitate control of process parameters (i.e., temperature, pressure, applied power, gas flow, and the like).

Additionally, the substrate support 116 comprises a heater electrode 151 that is coupled to a power source assembly 150. The heater electrode 151 is utilized to maintain the substrate support 116 and resultantly the substrate 114 at a desired temperature, such as 350 degrees Celsius (C.).

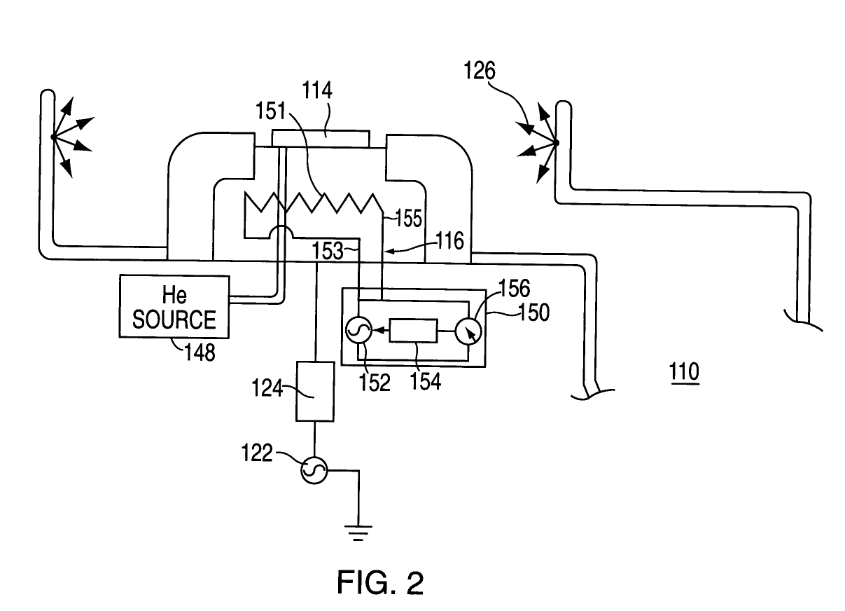

FIG. 2 depicts a detailed view of the substrate support 116. In particular, the substrate support 116 comprises a heater electrode 151 having a first lead 153 and second lead 155 coupled to a power source assembly 150 that is positioned external to the conductive chamber wall 130. The power source assembly 150 comprises a power source 152 coupled to the first lead 153 of the heater electrode 151, and a meter 156 coupled between the power source 152 and the second lead 155 of the heater electrode 151. Furthermore, a controller 154 is coupled between the power source 152 and the meter 156 to control the power source 152 based upon heater electrode condition. Specifically, the resistance of the heater electrode 151, as a function of temperature, is used to control power applied to the heater electrode.

It is well known in the art that the resistance of any material with a uniform cross-sectional area is influenced by the kind of material, length, cross-sectional area and temperature of the conductor. The resistivity is a measurement of the characteristic of the material at some specified temperature. Under normal conditions, the resistivity (i.e., of metals) increases linearly with temperature.

As such, Resistance R (ohms)=r(L/A) where

r=resistivity of the specific type of conductor,

L=length of the conductor, and

A=cross-sectional area.

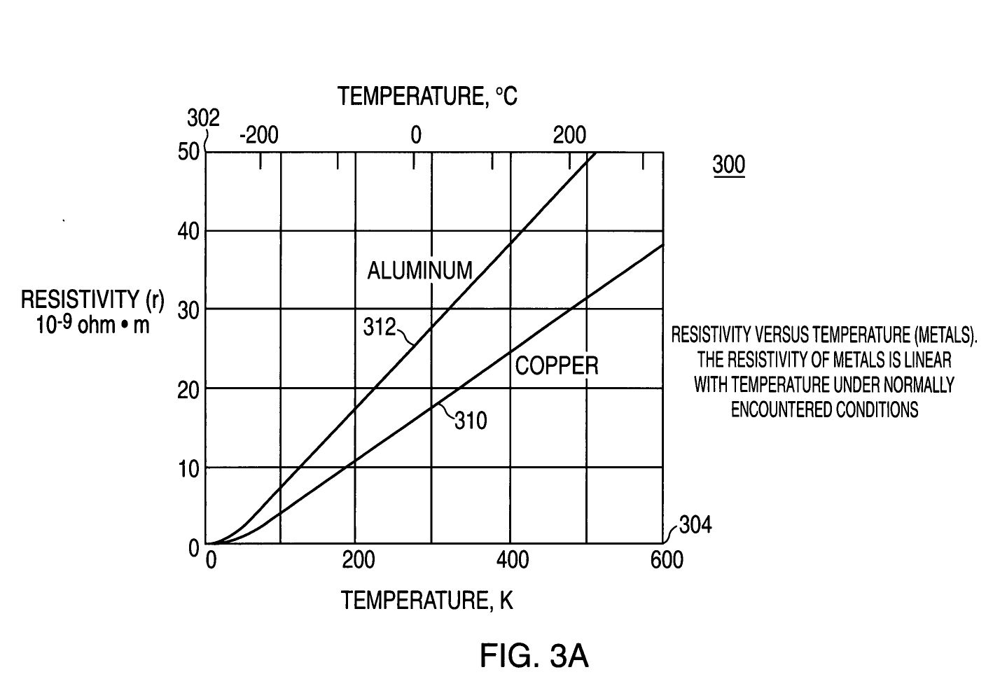

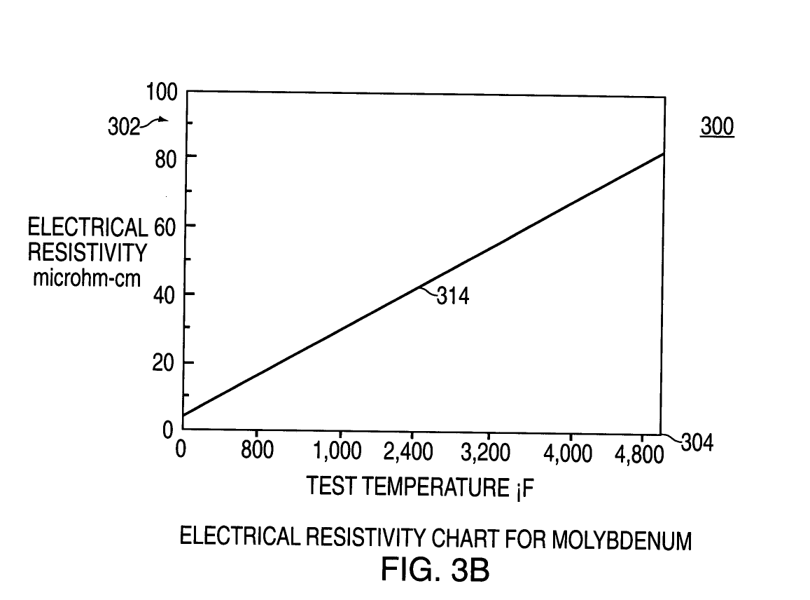

FIGS. 3A and 3B depict graphs of resistivity versus temperature for various metals. Specifically, the graph in FIG. 3A illustrates the change in resistivity for copper and aluminum conductors as a function of temperature. The graph 300 comprises resistivity values on the Y-axis 302 and temperature values on the X-axis 304. The graph 300 shows that the curves for both copper 310 and aluminum 312 are linear in shape. Likewise, the graph in FIG. 3B illustrates the same linear relationship as between the resistivity and temperature values for the metal Molybdenum 314. For most metal conductors, resistivity and accordingly, resistance rises with increases in temperature, due to the increased molecular vibrations within the conductor, which hinders the flow of mobile electron charges. Thus, the slope of the curve is positive.

These aforementioned properties of a conductor are advantageously utilized in the subject invention. The heater electrode 151 is fabricated from a conductive material suitable for use in high temperature (i.e., approximately 350° C.) conditions. Preferably, the electrode 151 is fabricated from Molybdenum. The resistance of the heater electrode 151 is periodically measured, and the current flow through the heater electrode 151 and the substrate support 116 may be adjusted to thereby control the temperature of the conductor. For example, the measured resistivity of Molybdenum is 5.17×10⁻⁸ ohm-meter at 20° C. Alternately, the resistivity of Molybdenum is approximately 7.5×10⁻⁸ ohm-meters at 350° C.

Referring to FIG. 2, in operation, the power source 152 supplies a steady flow of charge through the heater electrode 151. The flow of charge thereby causes the temperature of the heater electrode 151 to rise as a result of the increased molecular movement. Coincidental to the heater electrode 151 receiving power, the meter 156 measures the current flow through the heater electrode 151 and generates a corresponding signal. The resulting signal is then sent to the controller 154 for conversion under Ohm's law to a resistive value, i.e., ohms. It is understood by those skilled in the art that any type of meter 156 may be utilized, such as a voltage meter, ohm meter, or resistivity meter, as long as the measured value may subsequently be converted by the controller 154 to a resistivity measurement, i.e., ohm-meter.

Once the controller 154 has received or converted the meter's 156 measured signal in ohms, the controller 154 then converts the resistance value into a temperature value. The conversion is based upon the known length, cross-sectional area and resistivity values of the heater electrode 151. Such values are constant to the specific design and manufacture of the heater electrode. In particular, a heater electrode fabricated from Molybdenum has a known resistivity value of 5.17×10⁻⁸ ohm-meters. The controller 154 periodically samples the resistance of the heater electrode 151 via the meter 156. Alternately, the controller 154 may continuously sample the resistance of the heater electrode 151 via the meter 156. Regardless of the sampling method used, the resistivity versus temperature curve for the heater electrode 151 is known (and provided by the controller 154) and the corresponding temperature of the heater electrode 151 is determinable. By sampling the resistance, and knowing the resistivity vs. temperature characteristic of the heater electrode 151, the temperature of the heater electrode 151 is tracked. Thus, the controller 154 can increase or decrease the temperature of the heater electrode 151 by increasing or decreasing the power provided by the power source 152. In this manner, the temperature of the heater electrode 151 and consequently, the substrate support may be monitored and controlled.

Referring to FIG. 1, in operation, the substrate 114 is placed on the substrate support 116 and gaseous components are supplied from a gas panel 138 to the process chamber 110 through entry ports 126. The plasma is ignited in the process chamber 110 by applying RF power from the RF sources 118 and 122 respectively to the antenna 112 and the substrate support 116.

The pressure within the interior of the etch chamber 110 is controlled using a vacuum pump 136 and a throttle valve 127 situated between the chamber 110 and the vacuum pump 136. The temperature at the surface of the chamber walls 130 is controlled using liquid-containing conduits (not shown) which are located in the walls 130 of the chamber 110.

The heater electrode 151 embedded in the substrate support 116 is used to generate heat through the substrate support 116 for temperature control. By using an appropriate heat transfer medium, either heating or cooling of the substrate support 116 can be accomplished. A helium gas flow from source 148 to channels formed by the back of the substrate 114 and grooves (not shown) on the substrate support surface is used to facilitate heat transfer between the substrate 114 and the substrate support 116. During an etch process, the substrate 114 is gradually heated by the plasma to a steady state temperature of approximately 30-130 degrees C.

To facilitate control of the chamber 110 as described above, the CPU 144 may be one of any form of general purpose computer processor that can be used in an industrial setting for controlling various chambers and subprocessors. The memory 142 is coupled to the CPU 144. The memory 142 may be one or more of readily available memory such as random access memory (RAM), read only memory (ROM), floppy disk, hard disk, or any other form of computer readable media or digital storage, and may be a part of a host computer at some remote location. The support circuits 146 are coupled to the CPU 144 for supporting the processor in a conventional manner. These circuits include cache, power supplies, clock circuits, input/output circuitry and subsystems, and the like. The control software that is used for implementing the etching process of the present invention is generally stored in memory 142 as a software routine. The software may also be stored and/or executed by a CPU that is remotely located from the hardware being controlled by the CPU. When executed by the CPU 144, the software routine contained in the computer readable memory transforms the general-purpose computer into a specific purpose computer (controller 140) that controls the chamber operation such that the etching process and the necessary temperature control is performed.

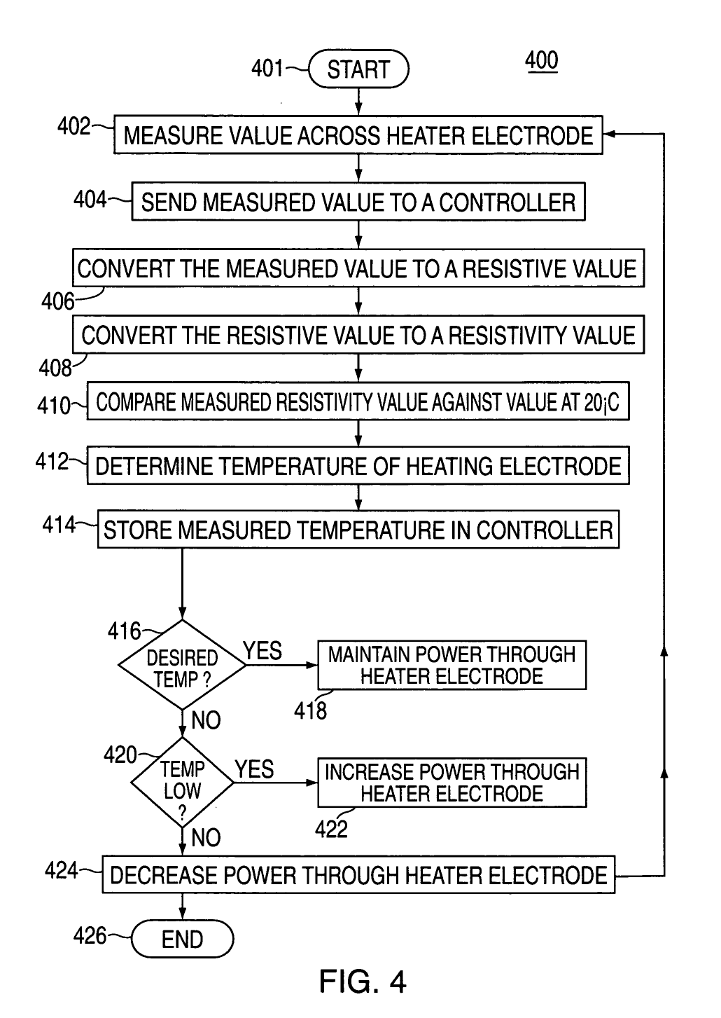

FIG. 4 depicts a flowchart of a method 400 of controlling temperature of a substrate support. It is to be understood that this method 400 can be practiced by hand or as part of the software routine discussed above. Specifically, the method 400 begins at step 401, and proceeds to step 402 where a meter, such as an amperage, voltage, resistance (ohms), or resistivity meter, measures the respective value across a heater electrode embedded in the substrate support. In step 404, the measured value, e.g., current flow (amps) is then sent to the controller for conversion to a temperature value. In step 406, the value measured by the meter is converted into a resistive value in accordance with Ohm's law. Once the controller has determined a resistive value, the resistivity value for the heater electrode is determined in step 408. The resistivity value is then stored in the memory (not shown) of the controller, and the method 400 proceeds to step 410.

In step 410, the measured resistivity is compared to the known resistivity value for the heater electrode stored in the memory of the controller. For example, the known resistivity value for a Molybdenum based heater electrode is 5.17×10⁻⁸ ohm-meter at 20° C.

In step 412, the determination of the temperature is based upon the linear attributes of the resistivity curve of a metal with respect to temperature. Therefore, since the slope of the curve is constant (see FIG. 3B), the temperature of the heater electrode may be readily calculated based upon the known and measured resistivity values. As such, in step 414, the temperature as observed from the reading of the meter is stored in the memory (not shown) of the controller. The controller will receive periodic updates of the meter readings for the heater electrode.

In step 416, the controller determines whether the temperature is a desired temperature for the heater electrode, and subsequently, the substrate support. If, in step 416, the temperature is the desired temperature, then the method 400 proceeds to step 418 where the controller maintains the present amount of output power at the power source. If, however, the temperature is not the desired temperature of the heater electrode, then the method 400 proceeds to step 420. In step 420, a determination is made by the controller as to whether the temperature of the heating electrode is too high or low. If, in step 420, the temperature is determined by the controller to be too low, then the method 400 proceeds to step 422, where the power source output is increased. Conversely, if in step 420, the determination is made that the temperature is too high, then the method 400 proceeds to step 424. In step 424, the power source output is decreased. In this manner, the controller may track the incremental readings of the heater electrode and make the appropriate adjustments to the power source in order to maintain a controlled temperature. Once a decision has been made and executed through any of steps 418, 422, or 424, the method returns to step 402 to take another measurement. This process continues until the particular wafer process ends and the method 400 ends at step 426.

Thus, the method and apparatus of actively-controlling a heater electrode embedded in a substrate support, advantageously allows the greater accuracy in determining the temperature of the substrate as opposed to the use of thermocouples. Furthermore, the apparatus and method inventively provide the ability to self-regulate the temperature by adjusting the power source to the heater electrode. Although several preferred embodiments that incorporate the teachings of the present invention have been shown and described in detail, those skilled in the art can readily devise many other varied embodiments that still incorporate these teachings.

What is claimed is:

1. An apparatus for controlling a temperature of a substrate during substrate processing, comprising:
a semiconductor substrate processing chamber;
a substrate support disposed in said chamber, said substrate support comprising a heater electrode adapted for connection to a power source and disposed within the substrate support;
a meter coupled to said heater electrode for measuring a characteristic of the heater electrode as an indicator of temperature of the heater electrode; and
a controller coupled to said meter and said power source, wherein said controller regulates power distribution to said heater electrode, via said power source, based upon a temperature of said heater electrode, where the temperature is determined by a measured resistivity of the heater electrode.

2. The apparatus of claim 1 wherein said heater electrode comprises molybdenum.

3. The apparatus of claim 1 wherein said power source is a voltage source.

4. The apparatus of claim 1 wherein said power source is a current source.

5. The apparatus of claim 1 wherein said controller determines the temperature of said heater electrode based upon the resistivity of said heater electrode.

6. The apparatus of claim 5 wherein the determination of the temperature of said heater electrode is based upon a measured resistivity of said heater electrode in comparison to a known resistivity value for such heater electrode at 20 degrees Celsius.

7. The apparatus of claim 6 wherein current and voltage levels across said heater electrode are maintained in an instance where said measured temperature is desirable.

8. The apparatus of claim 6 wherein current and voltage levels across said heater electrode are increased in an instance where said measured temperature is low.

9. The apparatus of claim 6 wherein current and voltage levels across said heater electrode are decreased in an instance where said measured temperature is high.

10. The apparatus of claim 1 wherein said processing chamber is at least one of an etch chamber and a deposition chamber.

11. An apparatus for controlling a temperature of a substrate during substrate processing, comprising:
a semiconductor substrate processing chamber;
a substrate support disposed in said chamber, said substrate support comprising a heater electrode embedded within said substrate support, said heater electrode having a first lead and a second lead;
a power supply coupled to said first lead of said heater electrode;
a meter coupled to said second lead of said heater electrode and said power supply for measuring a characteristic of the heater electrode as an indicator of temperature of the heater electrode; and
a controller coupled to said meter and said power source, wherein said controller regulates power distribution to said heater electrode, via said power source, based upon a temperature of said heater electrode, where the temperature is determined from a measured resistivity of the heater electrode.

12. The apparatus of claim 11 wherein said heater electrode comprises molybdenum.

13. The apparatus of claim 11 wherein said power source is a voltage source.

14. The apparatus of claim 11 wherein said power source is a current source.

15. The apparatus of claim 11 wherein said controller determines the temperature of said heater electrode based upon the resistivity of said heater electrode.

16. The apparatus of claim 15 wherein the determination of the temperature of said heater electrode is based upon a measured resistivity of said heater electrode in comparison to a known resistivity value for such heater electrode at 20 degrees Celsius.

17. The apparatus of claim 16 wherein a present power level across said heater electrode is maintained in an instance where said measured temperature is desirable.

18. The apparatus of claim 16 wherein a present power level across said heater electrode is increased in an instance where said measured temperature is low.

19. The apparatus of claim 16 wherein a present power level across said heater electrode is decreased in an instance where said measured temperature is high.

20. The apparatus of claim 11 wherein said processing chamber is at least one of an etch chamber and a deposition chamber.
